(19) United States
(12) Patent Application Publication
(10) Pub. No.: US 2013/0298485 A1
(43) Pub. Date: Nov. 14, 2013

(54) WIND TURBINE FOUNDATION MOUNTING PART SUPPORT SYSTEM

(71) Applicants: Rui Li, Shanghai (CN); Ingo Paura, Meppen (DE); Wolfgang Fuellhaas, Ibbenburen (DE); Radha Krishna Yerra, Nallajerla (IN)

(72) Inventors: Rui Li, Shanghai (CN); Ingo Paura, Meppen (DE); Wolfgang Fuellhaas, Ibbenburen (DE); Radha Krishna Yerra, Nallajerla (IN)

(73) Assignee: General Electric Company, Schenectady, NY (US)

(21) Appl. No.: 13/980,458

(22) PCT Filed: Jan. 21, 2011
(86) PCT No.: PCT/CN11/00100

§ 371 Date: Jul. 18, 2013

(51) Int. Cl. F03D 11/04; E02D 27/42

(52) U.S. Cl. CPC F03D 11/045; E02D 27/42
USPC 52/292

(57) ABSTRACT

A system for supporting a foundation mounting part connected to a tower of a wind turbine extending upward from a foundation and coupled to the foundation by the foundation mounting part is described. The system includes a first support block and a second support block. The first support block is positioned adjacent a first portion of the foundation mounting part. The second support block is slidably coupled to the first support block and at least a portion of the second support block is positioned between the first support block and the second support block. The second support block is configured to exert force on the first support block when displaced laterally with respect to a first axis coincident with a longitudinal axis of the tower.

### BACKGROUND OF THE INVENTION

The subject matter described herein relates generally to wind turbines and, more particularly, to a system for supporting a foundation mounting part.

Known wind turbines convert the kinetic energy of wind into electrical energy. Wind turbines include one or more blades coupled to a rotatable hub that rotate when oncoming wind strikes the blades. The flow of wind over the wind turbine blades generates lift, induces rotation, and provides torque to generate power. The pitch of the blades is controlled by a pitch assembly which couples the blades to a rotatable hub.

At least some known wind turbines have a tower that extends vertically upwards from a foundation. A foundation mounting part or other similar structure is encased in the foundation during construction of the foundation. The tower is coupled to a portion of the foundation mounting part that extends above an upper surface of the foundation. During operation of the wind turbine, an area of the foundation adjacent the foundation mounting part may experience increased wear. This increased wear may require repairs to be made to the foundation and/or foundation mounting part.

### BRIEF DESCRIPTION OF THE INVENTION

In one aspect, a system for supporting a foundation mounting part connected to a tower of a wind turbine is provided. The wind turbine tower extends upward from a foundation and is coupled to the foundation by the foundation mounting part. The system comprises a first support block positioned adjacent a first portion of the foundation mounting part and a second support block slidably coupled to the first support block. At least a portion of the second support block is positioned between the first support block and the foundation. The second support block is configured to exert force on the first support block when displaced laterally with respect to a first axis coincident with a longitudinal axis of the tower.

In another aspect, a system for supporting a foundation mounting part connected to a tower of a wind turbine is provided. The wind turbine tower extends upward from a foundation and is coupled to the foundation by the foundation mounting part. The system comprises a first support block having a first surface and a second surface. The first surface is adjacent the foundation mounting part. A second support block is provided and has a first surface. The second support block is coupled to the first support block and at least a portion of the first surface of the second support block is adjacent the second surface of the first support block. A coupling mechanism is provided for coupling the second support block to the first support block. The second support block is configured to exert force on the first support block when displaced laterally with respect to a first axis coincident with a longitudinal axis of the tower.

In another aspect, a foundation base for a wind turbine is provided. The system comprises a foundation having an upper surface. The wind turbine has a tower extending upward from the foundation. A foundation mounting part is provided and has a first section and a second section. The first section extends above the upper surface of the foundation and is coupled to the tower. The second section is encased in the foundation. A support block having a first surface is also provided. The support block is slidably coupled to the foundation mounting part and at least a portion of the first surface is positioned adjacent the foundation mounting part. The support block is configured to exert force on at least one of the upper surface of the foundation and the foundation mounting part when displaced laterally with respect to a first axis coincident with a longitudinal axis of the tower.

### BRIEF DESCRIPTION OF THE DRAWINGS

FIG. 1 is a side perspective view of an exemplary wind turbine.

FIG. 2 is a partial sectional view of an exemplary nacelle suitable for use with the wind turbine shown in FIG. 1.

FIG. 3 is an enlarged portion of the exemplary wind turbine of FIG. 1.

FIG. 4 is a partial cross-sectional view of FIG. 3 taken along the line 4-4 of FIG. 3.

FIG. 5. is a partial cross-sectional view of FIG. 4 taken along the line 5-5 of FIG. 4.

FIG. 6 is an enlarged view of FIG. 5 showing components of an exemplary foundation support block system.

FIG. 7 is an enlarged view of FIG. 5 showing components of another embodiment of a foundation support block system

### DETAILED DESCRIPTION OF THE INVENTION

The embodiments set forth herein describe systems used to support a foundation mounting part in a wind turbine. In these systems, support blocks are positioned between the foundation mounting part and a foundation which supports the wind turbine. The support blocks are slidably coupled to each other and configured to exert force upon the foundation and foundation mounting part to prevent accelerated degradation of the foundation due to flexure of the foundation mounting part.

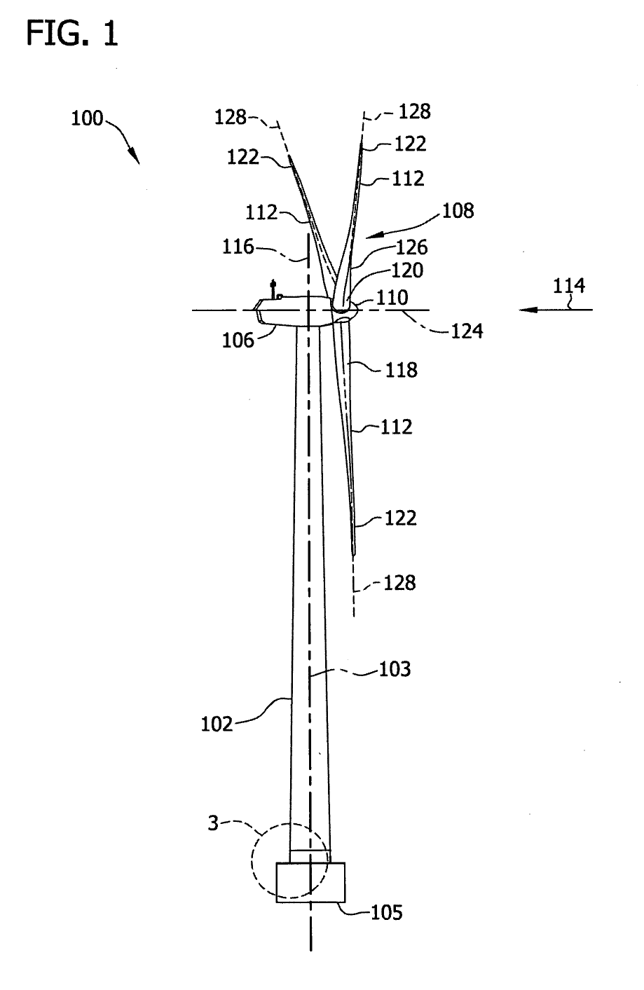

FIG. 1 is a schematic view of an exemplary wind turbine 100. In the exemplary embodiment, wind turbine 100 is a horizontal-axis wind turbine. Alternatively, wind turbine 100 may be a vertical-axis wind turbine. In the exemplary embodiment, wind turbine 100 includes a tower 102 extending from and coupled to a foundation 105 (broadly, a “support surface”). Tower 102 may be coupled to foundation 105 with anchor bolts with a foundation mounting part 104 (discussed and shown in greater detail below) encased within foundation 105, for example. Tower 102 has a first axis 103 that is coincident with a longitudinal centerline or axis of tower 102.

A nacelle 106 is coupled to tower 102, and a rotor 108 is coupled to nacelle 106. Rotor 108 includes a rotatable hub 110 and a plurality of rotor blades 112 coupled to hub 110. In the exemplary embodiment, rotor 108 includes three rotor blades 112. Alternatively, rotor 108 may have any suitable number of rotor blades 112 that enables wind turbine 100 to function as described herein. Tower 102 may have any suitable height and/or construction that enables wind turbine 100 to function as described herein.

Rotor blades 112 are spaced about hub 110 to facilitate rotating rotor 108, thereby transferring kinetic energy from wind 114 into usable mechanical energy, and subsequently, electrical energy. Rotor 108 and nacelle 106 are rotated about tower 102 on a yaw axis 116 to control a perspective of rotor blades 112 with respect to a direction of wind 114. Rotor blades 112 are mated to hub 110 by coupling a rotor blade root portion 118 to hub 110 at a plurality of load transfer regions 120. Load transfer regions 120 each have a hub load transfer region and a rotor blade load transfer region (both not shown in FIG. 1). Loads induced to rotor blades 112 are transferred to hub 110 via load transfer regions 120. Each rotor blade 112 also includes a rotor blade tip portion 122.

In the exemplary embodiment, rotor blades 112 have a length of between approximately 30 meters (m) (99 feet (ft)) and approximately 120 m (394 ft). Alternatively, rotor blades 112 may have any suitable length that enables wind turbine 100 to function as described herein. For example, rotor blades 112 may have a suitable length less than 30 m or greater than 120 m. As wind 114 contacts rotor blade 112, lift forces are induced to rotor blade 112 and rotation of rotor 108 about an axis of rotation 124 is induced as rotor blade tip portion 122 is accelerated.

A pitch angle (not shown) of rotor blades 112, i.e., an angle that determines the perspective of rotor blade 112 with respect to the direction of wind 114, may be changed by a pitch assembly (not shown in FIG. 1). More specifically, increasing a pitch angle of rotor blade 112 decreases an amount of rotor blade surface area 126 exposed to wind 114 and, conversely, decreasing a pitch angle of rotor blade 112 increases an amount of rotor blade surface area 126 exposed to wind 114. The pitch angles of rotor blades 112 are adjusted about a pitch axis 128 at each rotor blade 112. In the exemplary embodiment, the pitch angles of rotor blades 112 are controlled individually.

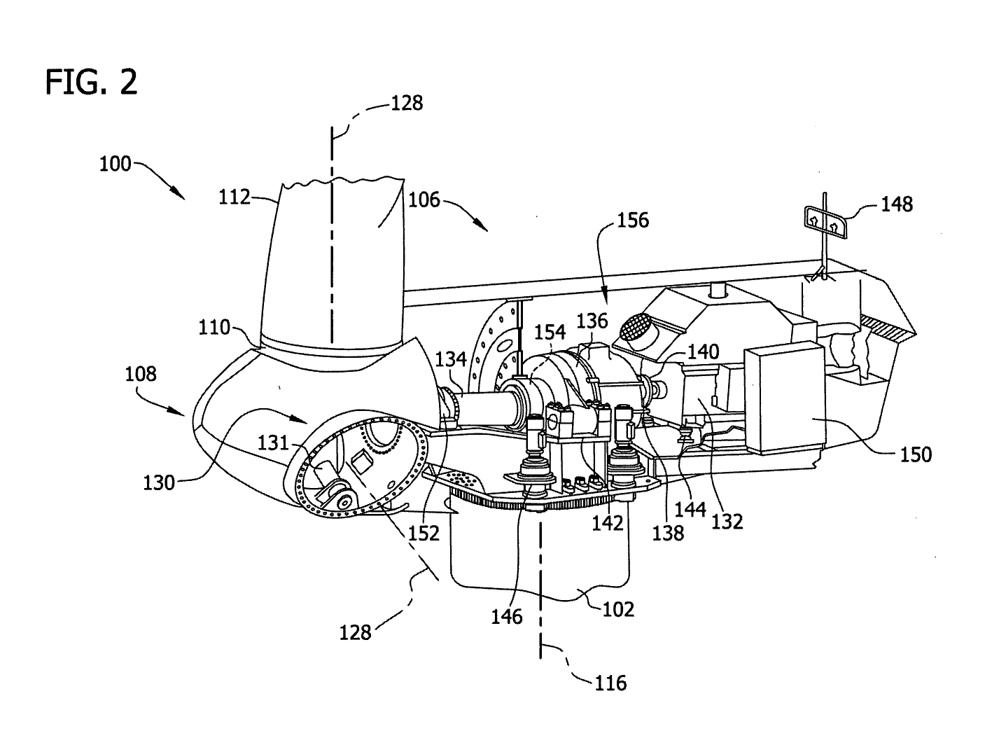

FIG. 2 is a partial sectional view of nacelle 106 of exemplary wind turbine 100 (shown in FIG. 1). Various components of wind turbine 100 are housed in nacelle 106. In the exemplary embodiment, hub 110 includes three pitch assemblies 130. Each pitch assembly 130 is coupled to an associated rotor blade 112 (shown in FIG. 1), and modulates a pitch of an associated rotor blade 112 about pitch axis 128. Only one of three pitch assemblies 130 is shown in FIG. 2. In the exemplary embodiment, each pitch assembly 130 includes at least one pitch drive motor 131.

As shown in FIG. 2, rotor 108 is rotatably coupled to an electric generator 132 positioned within nacelle 106 via a rotor shaft 134 (sometimes referred to as either a main shaft or a low speed shaft), a gearbox 136, a high speed shaft 138, and a coupling 140. Rotation of rotor shaft 134 rotatably drives gearbox 136 that subsequently drives high speed shaft 138. High speed shaft 138 rotatably drives generator 132 via coupling 140 and rotation of high speed shaft 138 facilitates production of electrical power by generator 132. Gearbox 136 is supported by a support 142 and generator 132 is supported by a support 144. In the exemplary embodiment, gearbox 136 utilizes a dual path geometry to drive high speed shaft 138. Alternatively, rotor shaft 134 is coupled directly to generator 132 via coupling 140.

Nacelle 106 also includes a yaw drive mechanism 146 that rotates nacelle 106 and rotor 108 about yaw axis 116 to control the perspective of rotor blades 112 with respect to the direction of wind 114. Nacelle 106 also includes at least one meteorological mast 148 that includes a wind vane and anemometer (neither shown in FIG. 2). In one embodiment, meteorological mast 148 provides information, including wind direction and/or wind speed, to a turbine control system 150. Turbine control system 150 includes one or more controllers or other processors configured to execute control algorithms. As used herein, the term “processor” includes any programmable system including systems and microcontrollers, reduced instruction set circuits (RISC), application specific integrated circuits (ASIC), programmable logic circuits (PLC), and any other circuit capable of executing the functions described herein. The above examples are exemplary only, and thus are not intended to limit in any way the definition and/or meaning of the term processor. Moreover, turbine control system 150 may execute a SCADA (Supervisory, Control and Data Acquisition) program.

Pitch assembly 130 is operatively coupled to turbine control system 150. In the exemplary embodiment, nacelle 106 also includes forward support bearing 152 and aft support bearing 154. Forward support bearing 152 and aft support bearing 154 facilitate radial support and alignment of rotor shaft 134. Forward support bearing 152 is coupled to rotor shaft 134 near hub 110. Aft support bearing 154 is positioned on rotor shaft 134 near gearbox 136 and/or generator 132. Nacelle 106 may include any number of support bearings that enable wind turbine 100 to function as disclosed herein. Rotor shaft 134, generator 132, gearbox 136, high speed shaft 138, coupling 140, and any associated fastening, support, and/or securing device including, but not limited to, support 142, support 144, forward support bearing 152, and aft support bearing 154, are sometimes referred to as a drive train 156.

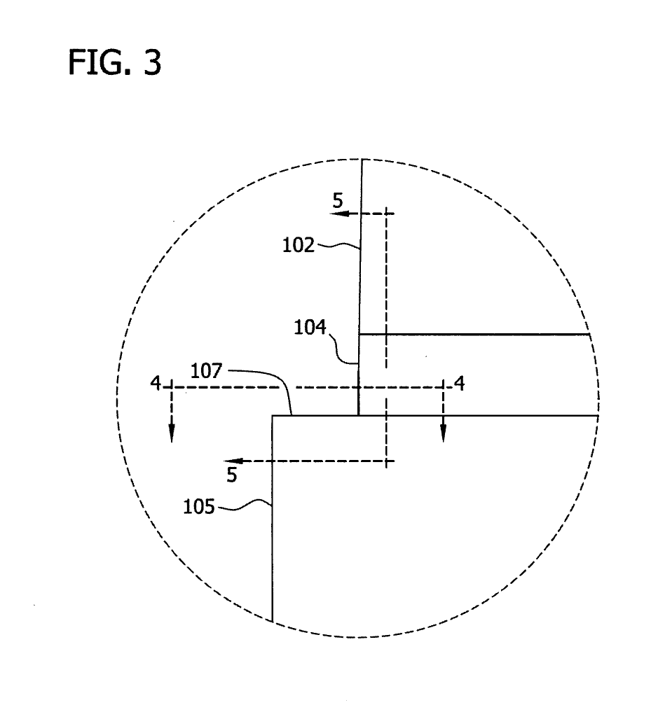

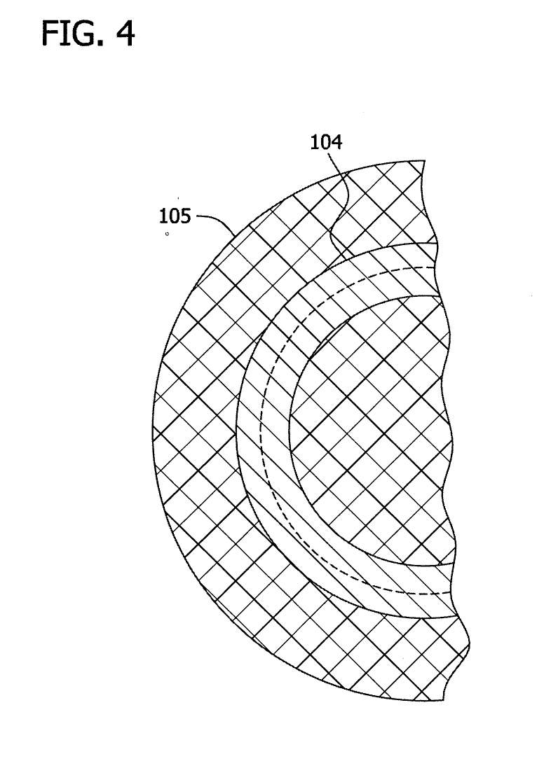

FIG. 3 illustrates an enlarged portion of FIG. 1 of wind turbine 100 shown in FIG. 1. Foundation mounting part 104 extends upward from foundation 105 and couples tower 102 of wind turbine 100 to foundation 105. Foundation 105 is formed from any suitable material, such as concrete. As shown in FIG. 4, which is a partial cross-section view of FIG. 3 taken along the line 4-4 in FIG. 3, foundation mounting part 104 extends around the circumference of tower 102.

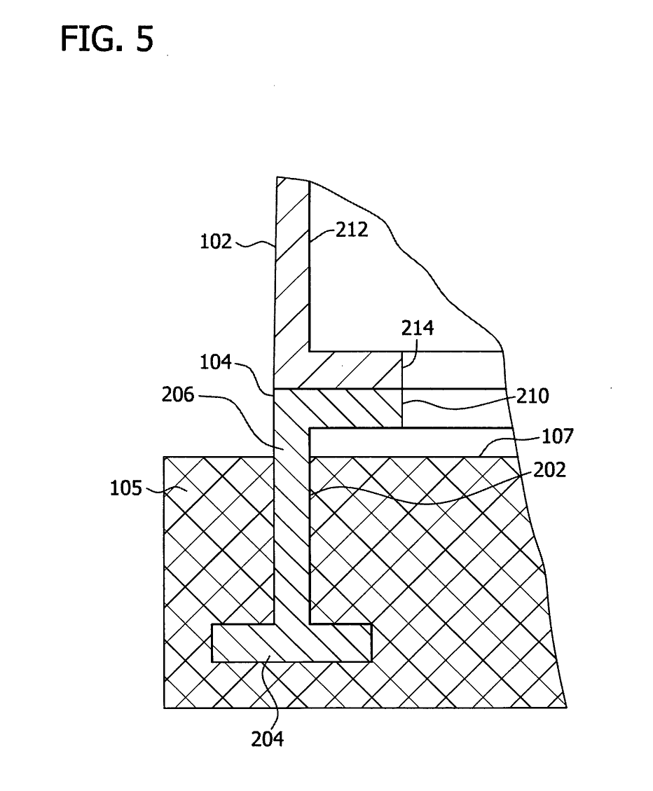

FIG. 5 is a partial cross-sectional view of FIG. 4 taken along the line 5-5 of FIG. 4. Components of the foundation support block system are not shown in FIG. 5 for the sake of clarity. As shown in FIG. 5, foundation mounting part 104 extends into foundation 105 and a lower portion 202 of foundation mounting part 104 is encased in foundation 105. Lower portion 202 terminates in a bottom flange 204. An upper portion 206 of foundation mounting part 104 extends upwardly from an upper surface 107 of foundation 105. A horizontal flange 210 (broadly, an “uppermost portion” of foundation mounting part 104) is included in upper portion 206 of foundation mounting part 104. A lower portion 212 of tower 102 is shown as well in FIG. 5 and likewise has a horizontal flange 214. Horizontal flange 214 of tower 102 and horizontal flange 210 of foundation mounting part 104 are coupled together by any suitable fastening system (not shown), such as threaded mechanical fasteners (i.e., nuts and bolts).

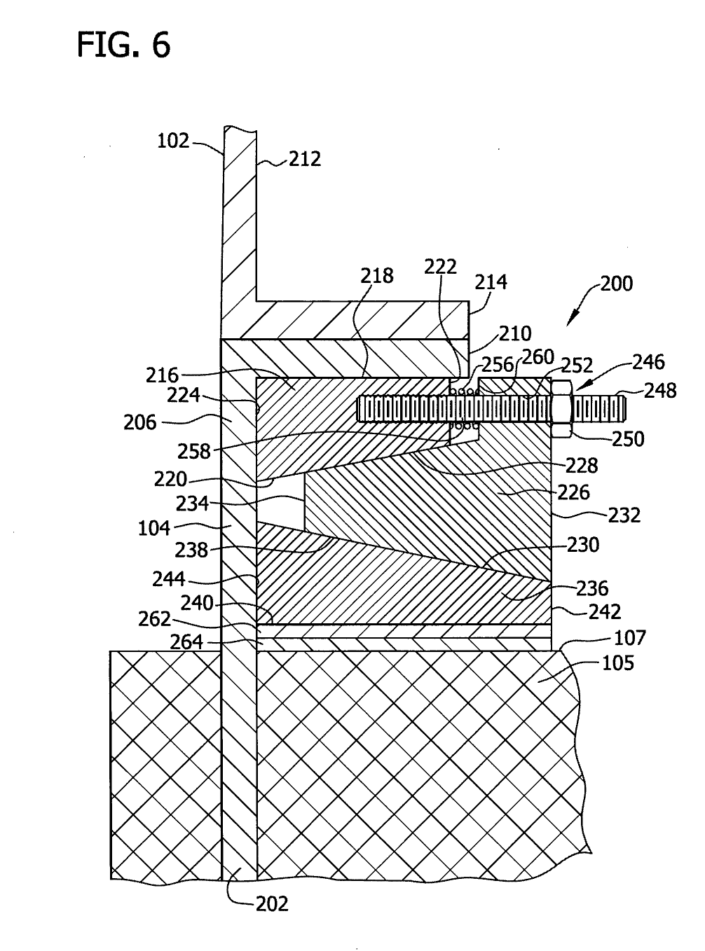

FIG. 6 is an enlarged view of FIG. 5 showing components of a foundation support block system 200 for supporting foundation mounting part 104. The components shown in system 200 are only one set of components shown in a single cross-sectional view. In the exemplary embodiment, multiple systems, the same as, or similar to, system 200 are disposed above the circumference of upper portion 206 of foundation mounting part 104 and lower portion 212 of tower 102.

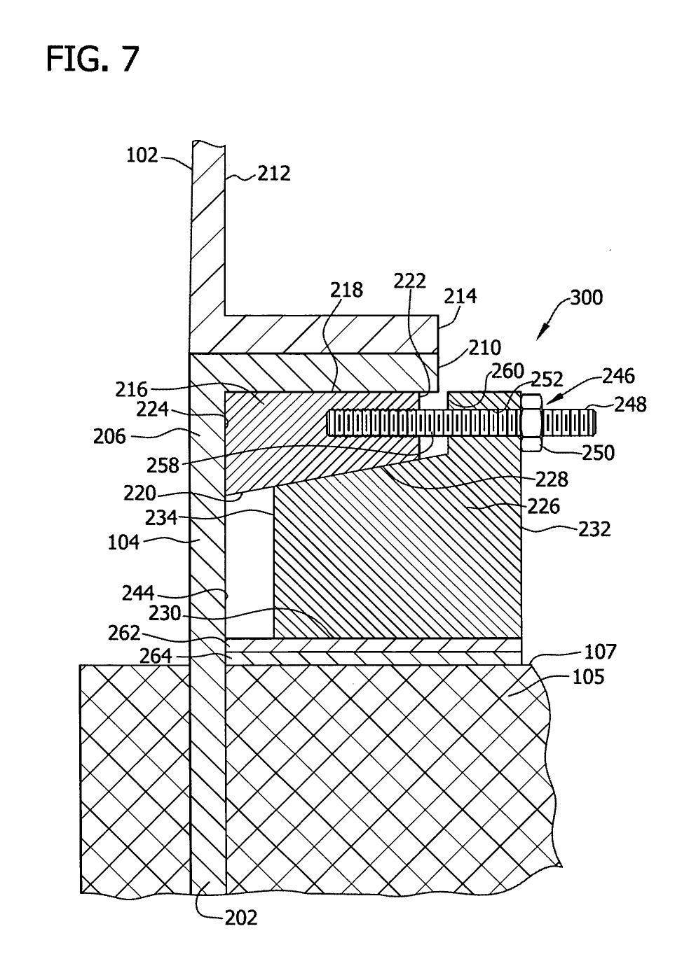

System 200 includes a first support block 216, a second support block 226, and a third support block 236. Each of support blocks 216, 226, 236 may be formed from any suitable material, such as steel, alloys thereof, or any other suitable rigid material. The relative sizes of the components of system 200 are exaggerated for the sake of clarity and accordingly should not be construed as limiting. Moreover, while the components of system 200 are shown as being positioned laterally inward of foundation mounting part 104 in the embodiments of FIGS. 6 and 7, the components may instead be positioned laterally outward from foundation mounting part 104 in other embodiments when foundation mounting part 104 is configured differently.

First support block 216 has an upper surface 218 and a lower surface 220. Upper surface 218 of first support block 216 is positioned adjacent horizontal flange 210 of foundation mounting part 104 and may be coupled to horizontal flange 210 with any suitable fastening system (not shown), such as threaded mechanical fasteners. In other embodiments, first support block 216 is not coupled to horizontal flange 210 and is instead retained in its position adjacent horizontal flange 210 by other components of system 200.

First support block 216 has an inner end 222 and an outer end 224, opposite inner end 222. Inner end 222 is nearer first axis 103 (shown in FIG. 1) of wind turbine 100 than outer end 224. Lower surface 220 of first support block 216 is inclined with respect to horizontal flange 210 in the exemplary embodiment such that first support block 216 has a thickness adjacent inner end 222 that is less than a thickness of first support block adjacent outer end 224.

Second support block 226 is positioned vertically beneath first support block 216 and has an upper surface 228 and a lower surface 230. Upper surface 228 of second support block 226 is positioned adjacent lower surface 220 of first support block 216. Second support block 226 has an inner end 232 and an outer end 234 opposite inner end 232. Inner end 232 is nearer first axis 103 of wind turbine 100 than outer end 234. Lower surface 230 and upper surface 228 of second support block 226 are inclined with respect to horizontal flange 210 in the exemplary embodiment such that the second support block 226 has a thickness adjacent inner end 232 that is greater than a thickness of second support block 226 adjacent outer end 234.

Second support block 226 is slidably coupled to first support block 216 by a coupling mechanism 246. Coupling mechanism 246 is a threaded fastener that includes a threaded stud 248 and a nut 250 in the embodiment illustrated in FIG. 6. Stud 248 is received within first support block 216 and may be fixed (e.g., with chemical, mechanical, and/or welding fastening systems) to first support block 216 to prevent rotation of stud 248 with respect to first support block 216. Stud 248 passes through an opening 252 in second support block 226. Nut 250 is coupled to stud 248 and positioned adjacent inner end 232 of second support block 226. A washer or other similar structure (not shown) may be positioned between nut 250 and inner end 232.

In the embodiment illustrated in FIG. 6, a biasing member 256 (e.g., a spring)) is positioned circumferentially around stud 248 adjacent a portion 258 of stud 248 between outer end 224 of first support block 216 and an upper shoulder 260 of second support block 226. In the exemplary embodiment, biasing member 256 is a coil spring and exerts a pre-loading type force against outer end 224 of first support block 216 and upper shoulder 260 of second support block 226. In other embodiments, different types of numbers of biasing members may be used, such as leaf springs or stacked Belleville washers. Moreover, in some embodiments biasing member 256 is not positioned circumferentially around stud 248 and is instead spaced from biasing member 256.

Third support block 236 is positioned vertically beneath second support block 226 and has an upper surface 238 and a lower surface 240. Upper surface 238 of third support block 236 is positioned adjacent lower surface 230 of second support block 226. Lower surface 240 of third support block 236 is positioned adjacent a spacer 262. Third support block 236 has an inner end 242 and an outer end 244 opposite inner end 242. Inner end 242 is nearer first axis 103 of wind turbine 100 than outer end 244. Upper surface 238 of third support block 236 is an inclined with respect to horizontal flange 210 in the exemplary embodiment such that third support block 236 has a thickness adjacent inner end 242 that is less than a thickness of third support block 236 adjacent outer end 244.

Spacer 262 is positioned vertically beneath lower surface 240 of third support block 236. A layer of grout 264 is disposed vertically above upper surface 107 of foundation 105 and vertically beneath lower surface 240 of third support block 236. Multiple spacers 262 may be used in different embodiments to account for different foundations having different distances between horizontal flange 210 of foundation mounting part 104 and upper surface 107 of foundation 105. Third support block 236 may be coupled to spacer 262, grout 264, and/or foundation 105 with any suitable fasteners. Moreover, some embodiments may not use spacer 262 and/or grout 264. In those embodiments, third support block 236 and spacer 262 are disposed on upper surface 107 of foundation 105.

FIG. 7 is an embodiment of a system 300 similar to the system 200 shown in FIG. 6 with the exception that only two support blocks are used, rather than the three used in system 200. Accordingly, like reference numerals are used to refer to like elements in system 300. Moreover, lower surface 230 of second support block 226 is substantially flat, and is thus not an inclined surface. In other embodiments, first support block 216 is not used and instead a lower surface of horizontal flange 210 of foundation mounting part 104 is an inclined surface having the same or similar profile as lower surface 220 of first support block 216. In such an embodiment, threaded stud 248 is received in an opening in horizontal flange 210 of foundation mounting part 104.

In operation, systems 200, 300 are operable to exert force on horizontal flange 210 of foundation mounting part 104 and upper surface 107 of foundation 105. Systems 200, 300 may be installed in an existing wind turbine 100 in a retrofit situation or systems 200, 300 may be installed during construction of wind turbine 100. In retrofit installations, tower 102 and horizontal flange 214 of tower 102 are raised and separated from horizontal flange 210 of foundation mounting part 104 by jacks or other similar devices.

Moreover, hydraulic jacks (not shown) may be positioned between horizontal flange 210 of foundation mounting part 104 and upper surface 107 of foundation 105. These hydraulic jacks may exert force on horizontal flange 210 of foundation mounting part 104 and upper surface 107 of foundation 105 in a similar manner to systems 200, 300. Once in place, the hydraulic jacks may be “locked” in place such that they continue to exert force on horizontal flange 210 of foundation mounting part 104 and upper surface 107 of foundation 105. These hydraulic jacks may be used in conjunction with other components of systems 200, 300. The components of systems 200, 300 and the hydraulic jacks may be broadly referred to as “force application members”.

Components of systems 200, 300 are then installed according to either of the embodiments shown in FIGS. 6 and 7. As described above, first support block 216 is coupled to horizontal flange 210 of foundation mounting part 104 (or any other part thereof). The components of systems 200, 300 may be installed in any suitable order. In retrofit applications, horizontal flange 214 of tower 102 is then lowered and coupled to horizontal flange 210 of foundation mounting part 104.

Nut 250 is then rotated with a wrench or other similar tool in a direction such that nut 250 exerts force on outer end 234 of second support block 226 in a lateral direction away from first axis 103 (shown in FIG. 1) such that second support block 226 is displaced laterally outwards away from first axis 103. In the exemplary embodiment, nut 250 is rotated in a clockwise direction to exert force on outer end 234 of second support block 226. As second support block 226 is displaced towards foundation mounting part 104 and first support block 216 is forced vertically upwards because of the mating inclined surfaces 220, 228 of first support block 216 and second support block 226. In the embodiment of system 200, third support block 236 is forced vertically downwards because of the mating inclined surfaces 230, 238 of second support block 226 and third support block 236. In the embodiment of systems 200, 300, spacer 262 is also forced vertically downwards because of the mating inclined surfaces of the support blocks 216, 226, 236.

The nut 250 may continue to be rotated with the wrench or other similar tool until a predetermined amount of force is applied by support blocks 216, 226, 236 to upper surface 107 of foundation 105 and/or horizontal flange 210 of foundation mounting part 104. The force applied by support blocks 216, 226, 236 to upper surface 107 of foundation 105 and/or horizontal flange 210 of foundation mounting part 104 may be calculated by measuring the elongation (i.e., strain) of foundation mounting part 104 with strain gauges or other similar devices. In an alternate embodiment, one or more load cells are positioned between any of support blocks 216, 226, 236, spacer 262, and/or upper surface 107 of foundation 105 and are utilized to calculate the forces applied.

The exertion of force on upper surface 107 of foundation 105 and/or horizontal flange 210 of foundation mounting part 104 has numerous benefits. One of these benefits is restricting movement of upper portion 206 of foundation mounting part 104 with respect to foundation 105. Restricting and/or eliminating movement of upper portion 206 of foundation mounting part 104 results in decreased and/or eliminated wear of these portions of foundation 105. Moreover, the force exerted by system 200 on upper surface 107 of foundation 105 also puts the portion of foundation adjacent system 200 in compression and results in this portion of foundation 105 being a pre-stressed structure and having the benefits of such a structure. Restricting and/or eliminating movement of upper portion 206 of foundation mounting part 104 and placing upper surface 107 of foundation 105 and areas near upper surface 107 in compression also decreases and/or eliminates force exerted by bottom flange 204 of foundation mounting part 104 on foundation 105. This decrease and/or elimination of force exerted by bottom flange 204 on foundation 105 reduces and/or eliminates wear of foundation 105 near bottom flange 204.

The examples used herein are illustrative only, and are not meant to be limited to the elements of those examples. The above-described embodiments provide an efficient and cost-effective system for reducing and/or eliminating wear of a foundation of a wind turbine. The systems permit portions of the foundation to be placed in compression and function as a pre-stressed structure. Moreover, the systems restrict and/or eliminate movement of the upper portion of the foundation mounting part which in turn reduces and/or eliminates wear of the foundation adjacent the foundation mounting part.

Exemplary embodiments of a wind turbine, a system for supporting a foundation mounting part of a wind turbine, and a method of installing the system are described above in detail. The wind turbine and system are not limited to the specific embodiments described herein, but rather, components of the turbine and/or system and/or steps of the method may be utilized independently and separately from other components and/or steps described herein. For example, the system may also be used in combination with other systems and methods, and is not limited to practice with only the wind turbine and method as described herein. Rather, the exemplary embodiment can be implemented and utilized in connection with many other wind turbine applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Wind Turbine Foundation Mounting Part Support System

PARTS LIST

| | |
|---|---|
| 100 | Wind turbine |
| 102 | Tower |
| 103 | First axis |
| 104 | Foundation mounting part |
| 105 | Foundation |
| 106 | Nacelle |
| 107 | Upper surface |
| 108 | Rotor |
| 110 | Hub |
| 112 | Rotor blades |
| 114 | Wind |
| 116 | Yaw axis |
| 118 | Rotor blade root portion |
| 120 | Load transfer regions |
| 122 | Rotor blade tip portion |
| 124 | Axis of rotation |
| 126 | Rotor blade surface area |
| 128 | Pitch axis |
| 130 | Pitch assembly |
| 131 | Drive motor |
| 132 | Generator |
| 134 | Rotor shaft |
| 136 | Gearbox |
| 138 | High speed shaft |
| 140 | Coupling |
| 142 | Support |
| 144 | Support |
| 146 | Yaw drive mechanism |
| 148 | Meteorological mast |
| 150 | Turbine control system |
| 152 | Forward support bearing |
| 154 | Aft support bearing |
| 156 | Drive train |
| 200 | System |
| 202 | Lower portion |
| 204 | Bottom flange |
| 206 | Upper portion |
| 210 | Horizontal flange |
| 212 | Lower portion |
| 214 | Horizontal flange |
| 216 | First support block |
| 218 | Upper surface |
| 220 | Lower surface |
| 222 | Inner end |
| 224 | Outer end |
| 226 | Second support block |
| 228 | Upper surface |
| 230 | Lower surface |
| 232 | Inner end |
| 234 | Outer end |
| 236 | Third support block |
| 238 | Upper surface |
| 240 | Lower surface |
| 242 | Inner end |
| 244 | Outer end |
| 246 | Coupling mechanism |
| 248 | Stud |
| 250 | Nut |
| 252 | Opening |
| 256 | Member |
| 258 | Portion |
| 260 | Upper shoulder |
| 262 | Spacer |
| 264 | Grout |
| 300 | Systems |

What is claimed is:

1. A system for supporting a foundation mounting part connected to a tower of a wind turbine, the wind turbine tower extending upward from a foundation and coupled to the foundation by the foundation mounting part, said system comprising:
a first support block positioned adjacent a first portion of the foundation mounting part; and,
a second support block slidably coupled to said first support block, at least a portion of said second support block positioned between said first support block and the foundation, said second support block configured to exert force on said first support block when displaced laterally with respect to a first axis coincident with a longitudinal axis of the tower.

2. A system in accordance with claim 1, wherein said second support block has a first surface and a second surface, and at least a portion of at least one of said first surface and said second surface is inclined.

3. A system in accordance with claim 1, wherein said second support block has a first end and a second end and a thickness, the thickness greater at the second end than at the first end, said first end proximate the foundation mounting part.

4. A system in accordance with claim 1, wherein the system is configured to extend between the foundation mounting part and the foundation and impart a compressive force on the foundation.

5. A system in accordance with claim 1, further comprising a coupling mechanism for slidably coupling said second support block to said first support block.

6. A system in accordance with claim 5, wherein said first support block and said second support block are configured such actuation of said coupling mechanism causes displacement of said second support block in a lateral direction away from the first axis.

7. A system in accordance with claim 1, wherein said first block is configured to be coupled to the foundation mounting part.

8. A system in accordance with claim 1, further comprising a third support block, at least a portion of said third support block positioned between said second support block and the foundation.

9. A system for supporting a foundation mounting part connected to a tower of a wind turbine, the wind turbine tower extending upward from a foundation and coupled to the foundation by the foundation mounting part, said system comprising:
a first support block having a first surface and a second surface, said first surface adjacent the foundation mounting part;
a second support block having a first surface, said second support block coupled to said first support block, at least a portion of said first surface of said second support block adjacent said second surface of said first support block; and,
a coupling mechanism for coupling said second support block to said first support block, said second support block configured to exert force on said first support block when displaced laterally with respect to a first axis coincident with a longitudinal axis of the tower.

10. A system in accordance with claim 9, wherein said first support block and said second support block are configured such that actuation of said coupling mechanism results in displacement of said second block in a direction away from the first axis.

11. A system in accordance with claim 9, wherein at least a portion of at least one of said first surface of said second support block and said second surface of said second support block is inclined.

12. A system in accordance with claim 9, wherein at least a portion of at least one of said first surface of said first support block and said second surface of said first support block is inclined.

13. A system in accordance with claim 9, wherein said second support block has a first end and a second end, said first end proximate the foundation mounting part.

14. A system in accordance with claim 13, wherein said second support block has a thickness, the thickness greater at the second end than at the first end.

15. A system in accordance with claim 9, further comprising a third support block having a first surface, said first surface of said third support block positioned adjacent said second surface of said second support block.

16. A system in accordance with claim 15, wherein said first surface of said third support block is inclined.

17. A foundation base system for a wind turbine, said system comprising:
a foundation having an upper surface, the wind turbine having a tower extending upward from the foundation;
a foundation mounting part having a first section and a second section, said first section extending above said upper surface of said foundation and coupled to the tower, said second section encased in said foundation; and,
a force application member, said force application member configured to exert force on at least one of said upper surface of said foundation and said foundation mounting part.

18. A system in accordance with claim 17, wherein said force application member comprises at least one of a hydraulic jack and a support block, said support block having a first surface, said support block slidably coupled to said foundation mounting part, at least a portion of said first surface positioned adjacent said foundation mounting part, said support block configured to exert force on at least one of said upper surface of said foundation and said foundation mounting part when displaced laterally with respect to a first axis coincident with a longitudinal axis of the tower.

19. A system in accordance with claim 18, further comprising a coupling mechanism for coupling said support block to said foundation mounting part, wherein actuation of said coupling mechanism results in displacement of said second block in a lateral direction away from the first axis.

20. A system in accordance with claim 18, further comprising a biasing member positioned between at least a portion of said support block and said foundation mounting part, said biasing member configured for biasing said support block in a direction towards the first axis.
